(19) United States
(12) Patent Application Publication
(10) Pub. No.: US 2010/0068682 A1
(43) Pub. Date: Mar. 18, 2010

(54) Phonetic words system and method

(76) Inventors: Kuojui Su, Van Nuys, CA (US); Ling-Ju Su, Van Nuys, CA (US)

Correspondence Address: Kuojui Su, 13936 Wyandotte St, Van Nuys, CA, 91405, US

(21) Appl. No.: 12/315,792

(22) Filed: Dec. 6, 2008

Related U.S. Application Data
(60) Provisional application No. 61/192,046, filed on Sep. 15, 2008.

(51) Int. Cl. G09B 1/00; G09B 17/00

(52) U.S. Cl. 434/159; 434/167; 434/178

(57) ABSTRACT

The present invention consists of simple phonetic marks combined with alphabet letters to form Phonetic Words for the reader to read words and learn the pronunciation at the same time. The phonetic marks are placed on appropriate letters to form phonetic words. Unique, simple marking rules are created to minimize the use of phonetic marks so the marks do not clutter letters and still retain their function.

### CROSS REFERENCE OF RELATED APPLICATION

This is a non-provisional application of a provision application having an application No. 61/192,046 and a filing date of Sep. 15, 2008.

### BACKGROUND OF THE PRESENT INVENTION

1. Field of Invention

The present invention relates to the pronunciation system and method of alphabet writing words, and more particularly to the incorporation of phonetic marks and the English alphabet letters to demonstrate word pronunciations.

2. Description of Related Arts

The English language is one of the most widely spoken languages in the world. The English vocabulary comprises of words composed of single or multiple vowels and consonants. An advantage of the English language is that its written word is formed by spelling method and thus allows the user to learn to read and write easily. A disadvantage of the language is that its pronunciations are not always clear from reading the words. One reason for this is that English has many spelling rules. In addition, many words are not spelled the way they are pronounced. As a result, many foreign English learners regard English as a difficult language to learn.

Although many countries have implemented an educational system that requires their school aged children to learn English as early as possible to better compete in the global economy where English is the universal language. Unfortunately, results have been poor in many countries, such as those in Eastern Asia, where the native languages are very different from English in pronunciation and written form. A prevalent problem is that while many students have strong English writing and word comprehension skills, they lack the ability to converse in English. Their poor conversational skills can be attributed to their lack of basic understanding of English pronunciation. While they can read and write, their poor pronunciation makes it difficult for others to understand them and for them to understand the words they hear. Furthermore, students who have poor pronunciation tend to have a more difficult time memorizing long, complicated words which affects their learning efficiency. If English words were spelled the way they are pronounced, as is the case of Spanish words, it would be much easier to learn English.

The present invention creates a new type of phonetic system and method that helps the student be able to pronounce words correctly as they read. The new type of phonetic system and method emphasizes the importance in locating stressed vowels in words by placing phonetic marks on the letters of stressed vowels to note the placements of the stressed vowels and at the same time indicate their correct pronunciation. The new phonetic system and method is not limited to use in learning English pronunciation. It can also be applied to learning the pronunciations of other languages.

### SUMMARY OF THE PRESENT INVENTION

A main object of the present invention is to provide a new type of phonetic system and method whereby the student can both read and learn word pronunciations at the same time. The merit of the new invention of the new phonetic system and method is that the reader can read and learn the pronunciations of the words they're reading without having to look up a dictionary.

The present invention consists of simple phonetic marks combined with alphabet letters to form phonetic words for the reader to read words and learn the pronunciations at the same time. The phonetic marks are placed on appropriate letters to form phonetic words. Unique, simple marking rules are created to minimize the use of phonetic marks so that the marks do not clutter the letters and still retain their function.

The new phonetic system and method contains long vowel marks and short vowel marks. These marks combine with letters to form phonetic words that show pronunciation.

### BRIEF DESCRIPTION OF THE DRAWINGS

FIG. 1 illustrates a paragraph incorporating the use of the phonetic words of the present invention.

FIG. 2 illustrates a paragraph incorporating the use of the present invention and is designed mainly for students with some basic knowledge of the English language.

FIG. 3 illustrates examples of phonetic words of the present invention.

### DETAILED DESCRIPTION OF THE PRESENT INVENTION

One of the challenges for students learning English is that many English words are not spelled the way they are pronounced. In addition, when reading or sounding a multi-syllabic word, one needs to know which syllable has the stressed vowel in order to pronounce the word correctly.

To better help English language students who wish to be able to read and see the pronunciations of the words they come across without interrupting their reading flow when having to look up a dictionary, the present invention expresses the sounds of stressed vowels by using phonetic marks. The phonetic marks not only express the sounds of the stressed vowels but also differentiate the stressed vowels from the unstressed vowels, which are un-marked. In effect, the phonetic markings also act as a stress mark. The advantage of marking stressed vowels with phonetic marks instead of using a regular stress mark is that the reader can see where the stressed vowel in each word is located and at the same time being able to see the correct pronunciation of the stressed vowel. Because only stressed vowels are marked, the use of marking is kept to a minimum to avoid cluttering of letters with marks. Since the sounds of unstressed vowels are governed by simple pronunciation rules (which will be explained below), once a stressed vowel is located and its vowel sound is denoted by a phonetic mark, the reader is then able to see the stressed vowel sound from the phonetic mark placed on the stressed vowel letter and at the same time figure out the unstressed vowel sound(s) by applying the pronunciation rules regarding unstressed vowels. Together with the phonetic marks denoting the sounds and placements of stressed vowels and the understanding of the rules governing unstressed vowels, the reader is able to obtain the correct pronunciation of each word he reads. Every English word has at least one stressed vowel. With this in mind, the present invention ensures that all words, whether monosyllabic or multi-syllabic, are indicated with phonetic marks that act as a pronunciation guide.

An unstressed vowel is a reduced vowel that is often pronounced like a schwa or i short vowel sound. Examples of unstressed short vowels being pronounced as a schwa sound include “a” in “fatigue”, “e” in “inter”, “i” in “mobile”, “o” in “dragon”, “u” in “cactus”. Examples of unstressed short vowels being pronounced as an i short vowel sound include “a” in “storage”, “e” in “market” or “i” in “basic”. An unstressed short vowel followed by a consonant is often influenced by the following consonant. For examples, an unstressed short vowel followed by an “l” sounding consonant is pronounced like a schwa sound, as in the case of “a” in “metal”, “e” in “bagel” , “i” in “pencil”, “o” in “methanol”, “u” in “consul”; an unstressed short vowel followed by a “j” sounding consonant is pronounced as a short “i” vowel, as in the case of “a” in “hostage”, “e” in “college”. an unstressed short vowel is followed by a “d”, “k”, “s” or “t” sounding consonant, it is pronounced as a short “i” vowel, as in the case of “e” in “cooked”, “e” in “perfect”, “e” in “cordless”, “e” in “market”, “i” in “humid”, “i” in “garlic”, “i” in “basis”, or “i” in “exit”; when unstressed long vowels, such as “e” in “return” is pronounced as a weaker version of the long “e” vowel; when unstressed long vowels, such as “o” in “auto” is pronounced as a weaker version of the long “o” vowel. The above mentioned rules cover a handful of rules concerning unstressed vowels. The rules governing unstressed vowels are consistent and easy to learn by studying the pronunciation patterns of words of similar structure. Once the student has learned the simple rules regarding unstressed vowels he will have no difficulty pronouncing unstressed vowels.

The phonetic marks mentioned herein are referenced in the U.S. Pat. No. 7,004,758 (Language Phonetic System and Method Thereof, inventor: Koujui Su) which will be summarized below. The patent includes the simple phonetic marks that are used in the present invention as suitable marks for marking stressed vowels and functioning as stress marks.

The present invention uses simple phonetic marks which are placed only on stressed vowels to denote the sound of each stressed vowel and to act as a stress mark. Most English words have only one stressed vowel. Under the present invention, many words will only need one phonetic mark to guide pronunciation. Such method not only makes it easy to see the stressed vowels without cluttering the letters, it also shows the correct pronunciations of words by showing the pronunciations of the stressed vowels.

The system and method of the present invention is detailed below:

(1) Only vowel letter(s) of stressed syllable(s) in a word are marked, wherein the mark(s) express the tone(s) and sound(s) of the vowel(s) being marked.

(2) When there is more than one stressed vowel in a word, the phonetic mark marking the primary stressed vowel will be in a bolder, more prominent style than the mark that marks the secondary stressed vowel in order to differentiate the primary stressed vowel from the secondary stressed vowel.

(3) When a stressed syllable is composed of more than one vowel letter, the vowel letter marked with a phonetic mark dictates the pronunciation of the vowel sound of the syllable. In other words, the pronunciation of the stressed vowel is expressed by the phonetic mark attached. Vowel letters in the same syllable not marked are mute. For example, when only the “u” in “beautiful” is marked with a phonetic mark (e.g. “bea\check{u}tiful”), the sound represented by the mark to indicate the “u” sound is the vowel sound of the entire stressed syllable “beaut”, and letters “e” and “a” which are without marking are mute. This is an easy and simple rule created for minimizing the use of phonetic marks.

(4) The present invention adopts the phonetic marks referenced in U.S. Pat. No. 7,004,758 (Language Phonetic System and Method Thereof, inventor: Koujui Su). The phonetic marks include: swing mark “ [symbol] ” placed above letter “a” to indicate long vowel “a” as in “cake”; swing mark “ [symbol] ” placed above letter “e” to indicate long vowel “e” as in “he”; swing mark “ [symbol] ” placed above “i to indicate long vowel “i” as in “like”; swing mark “ [symbol] ” placed above “y” to indicate long vowel “y” as in “by”; swing mark “ [symbol] ” placed above “o” to indicate long vowel “o” as in “tote”; swing mark “ [symbol] ” placed above “u” to indicate long vowel “u”, as in “tube”; swing mark “ [symbol] ” placed above “ew” to indicate long vowel “ew” as in “new”; swing mark “ [symbol] ” placed above “oi” to indicate long vowel “oi” as in “boil”; swing mark “ [symbol] ” placed above “oy” to indicate long vowel “oy” as in “oyster”; swing mark “ [symbol] ” placed above “oo” to indicate long vowel “oo” as in “food”; swing mark “ [symbol] ” placed above “ou” to indicate long vowel “ou” as in “house”; swing mark “ [symbol] ” placed above “ow” to indicate long vowel “ow” as in “power”; phonetic mark “ [symbol] ” placed on any vowel letter to express that the vowel sound is pronounced as “a” in “hat”; phonetic mark “ [symbol] ” placed on any vowel letter to express that the vowel sound is pronounced as “e” in “set”; phonetic mark “ [symbol] ” placed on any vowel letter to express that the vowel sound is pronounced as “i” in “sit”; phonetic mark “•• ” placed on any vowel letter to express that the vowel sound is pronounced as “o” in “top” phonetic mark “ [symbol] ” placed on any vowel to express that the vowel sound is pronounced as “o” in “lost” or “a” in “fall”; phonetic mark “ [symbol] ” placed on any vowel letter(s) to express that the vowel sound is pronounced as “u” in “push” or “oo” in “book”; phonetic mark “-- ” placed on any vowel letter to express that the vowel sound is pronounced as “u” in “bus” or “o” in “come”; phonetic mark “• ” placed on any vowel letter to express that the vowel sound is pronounced as “u” “curve” or “e” in “sister”.

(5) The system and method of the present invention is a good instructional tool for teaching English. Instructional or educational materials that utilize the present invention can be presented in different formats, such as in the forms of books, computer hardware, software or interactive media.

(6) The system and method meets the needs of different types of users at various levels. Language students use it to learn pronunciation and to be able to better memorize spellings of words; students in specialized studies such as engineering or medicine use it to better learn the pronunciations of special words, names or terminologies they encounter in their studies.

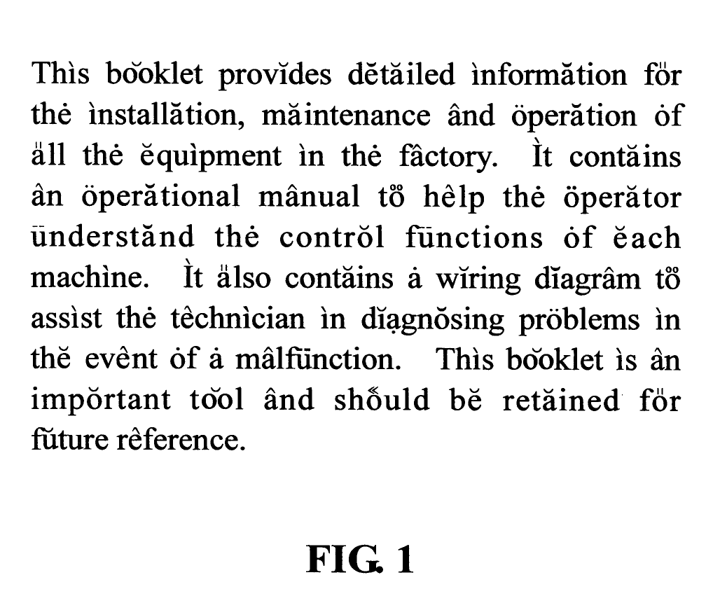

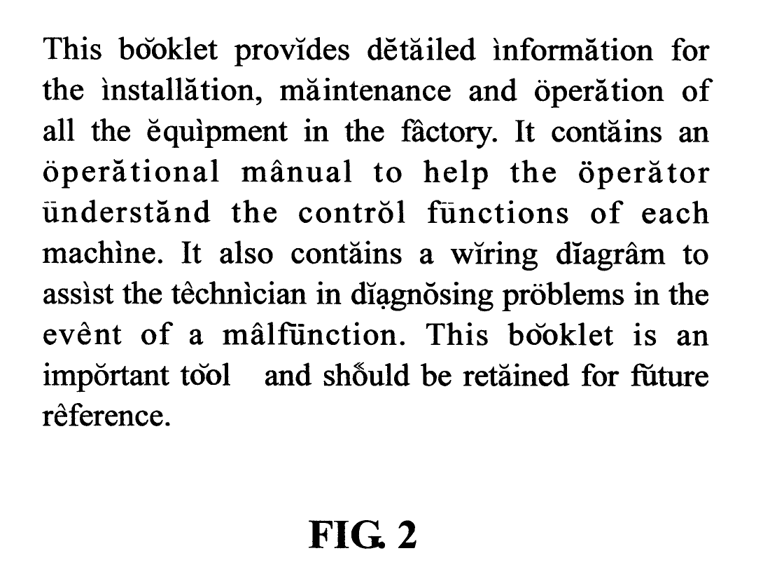

Referring to FIGS. 1, 2 & 3, the new phonetic English according to the present invention is illustrated:

FIG. 1 illustrates a paragraph incorporating the use of the present invention. All the words are phonetic words which show the pronunciation of each word by noting each word's stressed vowel with a phonetic mark expressing the sound of the vowel. The mark functions both as a phonetic mark and a stress mark indicating the sound and placement of the stressed vowel. The paragraph in FIG. 1 is designed mainly for English beginners.

FIG. 2 illustrates a paragraph incorporating the use of the present invention. The paragraph contains phonetic words which show the pronunciation of each word by noting each word's stressed vowel with a phonetic mark expressing the sound of the vowel. The mark functions both as a phonetic mark and a stress mark indicating the sound and placement of the stressed vowel. The paragraph in FIG. 2 is designed mainly for students with some basic knowledge of the English language.

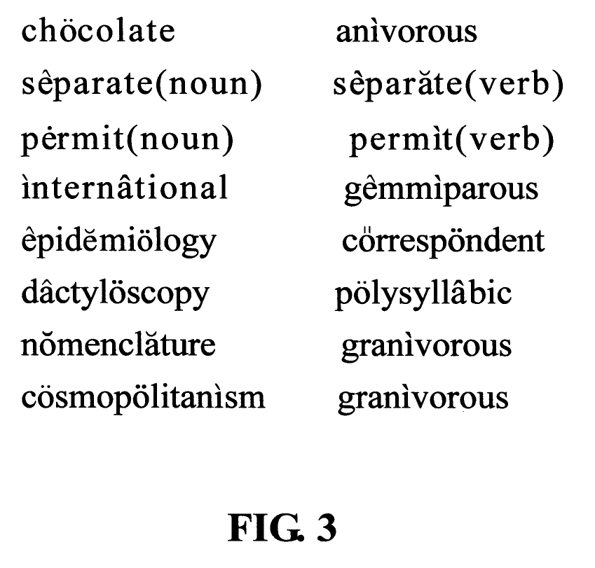

FIG. 3 illustrates the phonetic words incorporating the use of the present invention. The phonetic words demonstrate that the present invention is especially effective in helping one learn the pronunciations of seldom used or more difficult words.

For beginners additional phonetic marks are added to further help them with pronunciation. For example, schwa mark “• ” is placed under “a” in “diagnose” to indicate that the “a” needs to be pronounced as a schwa sound. Single underline is used to indicate the alternative pronunciation of the consonants, such as “s” in “resume”. Double underline is used to indicate that the consonant noted is mute, such as “b” in “debt”.

The present invention provides an effective system and method of teaching English and helping the student learn English more efficiently. The advantages of the present invention include: 1) preventing the learner from guessing the pronunciations of words, which in term prevents the learner from having bad pronunciation; 2) reinforcing words, which in term prevents the learner from having bad pronunciation; 2) reinforcing the importance of the general pronunciation rules regarding unstressed vowels which helps the learner understand the characteristic of English pronunciation and speed up his learning progress; 3) helping the learner gain more confidence in his pronunciation and thereby helps raise his learning interest and efficiency; 4) saving the learner time from having to look up a dictionary for pronunciation and thereby saves time that can be used for more reading to speed up his learning progress.

English, due to its wide usage, is herein used as an example to demonstrate the application of the present invention. However, the system and method of the present invention is not limited to expressing English pronunciation only. It can also be applied to other languages as well. While some adjustments may be needed for the phonetic marks to reflect the specific sounds unique to a language, the method and the spirit of the present invention remains the same, regardless of the language to which it is applied.

What is claimed is:

1. A phonetic system for marking symbols directly onto alphabet letter words to show pronunciation, comprising;
vowel letters of stressed syllables being marked with a plurality of phonetic marks to express the vowel tones and sounds of said stressed syllables; and
vowel sound of each stressed syllable containing more than one vowel letter is expressed by whichever vowel letter is marked with a said phonetic mark, and other vowel letters within said stressed syllable are treated as mute when they are without markings.

2. The phonetic system, as recited in claim 1, wherein vowel letters having long vowel sounds are marked with a same phonetic mark to indicate said vowel letters are long vowels.

3. The phonetic system, as recited in claim 1, wherein vowel sounds of short vowel letters are expressed by a plurality of different phonetic marks each representing a specific short vowel sound and each said short vowel letter is pronounced as the sound each said specific phonetic mark attached represents.

4. The phonetic system, as recited in claim 1, wherein said phonetic marks used to mark the tones and sounds of primary stressed vowels are in bolder type than said phonetic marks used to mark the tones and sounds of secondary stressed vowels.

5. The phonetic system, as recited in claim 1, wherein said phonetic system can be used in any printing or electronic medium.

6. The phonetic system, as recited in claim 5, wherein said phonetic system can be applied to different languages.

7. The phonetic system, as recited in claim 6, further comprising having phonetic marks placed underneath letters for more detailed instructional purpose for the beginning learner.

8. A method for marking phonetic symbols directly onto English words to show pronunciation, comprising the steps of:
(a) placing a plurality of phonetic marks on vowel letters of stressed syllables to express the vowel sounds of said stressed syllables and;
(b) defining the vowel sound of each stressed syllable containing more than one vowel letter as expressed by whichever vowel letter is marked with a said phonetic mark, and other vowel letters within said stressed syllable are treated as mute when they are without markings.

9. The phonetic method, as recited in claim 8, having a same phonetic mark being marked on vowel letters with long vowel sounds to express said vowel letters have long vowel sounds.

10. The phonetic method, as recited in claim 8, wherein vowel sounds of short vowel letters are expressed by a plurality of different phonetic marks each representing a specific short vowel sound and each said short vowel letter is pronounced as the sound each said specific phonetic mark attached represents.

11. The phonetic method, as recited in claim 8, having said phonetic marks expressing the sounds of primary stressed vowels in a bolder style than said phonetic marks expressing the sounds of secondary stressed vowels.

12. The phonetic system, as recited in claim 8, wherein said phonetic system can be used in any printing or electronic medium.

13. The phonetic system, as recited in claim 12, wherein said phonetic system can be applied to different languages.

14. The phonetic method, as recited in claim 13, further comprising having phonetic marks placed underneath letters for more detailed instructional purpose for the beginning learner.

15. A written language composing of English phonetic words, wherein said words are English words marked with phonetic markings, comprising:
(a) vowel letters of stressed syllables being marked with a plurality of phonetic marks to express the vowel tones and sounds of said stressed syllables; and
(b) vowel sound of each stressed syllable containing more than one vowel letter is expressed by whichever vowel letter is marked with a said phonetic mark, and other vowel letters within said stressed syllable are treated as mute when they are without markings.

16. The English phonetic word language, as recited in claim 15, wherein said phonetic marks used to mark the tones and sounds of primary stressed vowels are in bolder type than said phonetic marks used to mark the tones and sounds of secondary stressed vowels.

17. The English phonetic word language, as recited in claim 15, wherein swing mark “ [symbol] ” placed above letter “a” to indicate long vowel “a” as in “cake”; swing mark “ [symbol] ” placed above letter “e” to indicate long vowel “e” as in “he”; swing mark “ [symbol] ” placed above “i to indicate long vowel “i” as in “like”; swing mark “ [symbol] ” placed above “y” to indicate long vowel “y” as in “by”; swing mark “ [symbol] ” placed above “o” to indicate long vowel “o” as in “tote”; swing mark “ [symbol] ” placed above “u” to indicate long vowel “u”, as in “tube”; swing mark“ [symbol] ” placed above “ew” to indicate long vowel “ew” as in “new”; swing mark “ [symbol] ” placed above “oi” to indicate long vowel “oi” as in “boil”; swing mark “ [symbol] ” placed above “oy” to indicate long vowel “oy” as in “oyster”; swing mark “ [symbol] ” placed above “oo” to indicate long vowel “oo” as in “food”; swing mark “ [symbol] ” placed above “ou” to indicate long vowel “ou” as in “house”; swing mark “ [symbol] ” placed above “ow” to indicate long vowel “ow” as in “power”; phonetic mark “ [symbol] ” placed on any vowel letter to express that the vowel sound is pronounced as “a” in “hat”; phonetic mark “ [symbol] ” placed on any vowel letter to express that the vowel sound is pronounced as “e” in “set”; phonetic mark “ [symbol] ” placed on any vowel letter to express that the vowel sound is pronounced as “i” in “sit”; phonetic mark “.. ” placed on any vowel letter to express that the vowel sound is pronounced as “o” in “top”; phonetic mark “ [symbol] ” placed on any vowel to express that the vowel sound is pronounced as “o” in “lost” or “a” in “fall”; phonetic mark “ [symbol] ” placed on any vowel letter(s) to express that the vowel sound is pronounced as “u” in “push” or “oo” in “book”; phonetic mark “-- ” placed on any vowel letter to express that the vowel sound is pronounced as “u” in “bus” or “o” in “come”; phonetic mark “. ” placed on any vowel letter to express that the vowel sound is pronounced as “u” “curve” or “e” in “sister”.

18. The English phonetic word language, as recited in claim 15, wherein said written language can be used in any printing or electronic medium.

19. A phonetic system of stressed marks for marking directly onto alphabet letter words to show the tones of the words comprising:
(a) stressed marks composed of a plurality of phonetic marks each expressing a specific vowel sound, wherein each said stressed mark is attached to a stressed vowel letter to indicate stressed status and express the tone and sound of the vowel letter to which said stressed mark is attached; and
(b) primary stressed marks are in a bolder style than secondary stressed marks.

20. A phonetic method of stressed marks for marking directly onto alphabet letter words to show the tones of the words comprising:
(a) attaching a plurality of phonetic marks acting as stressed marks to a plurality of stressed vowel letters, wherein each said stressed mark is a phonetic mark indicating stressed status and expressing the sound of vowel letter to which said stressed mark is attached; and
(b) expressing phonetic marks for primary stressed vowels in a bolder style than secondary stressed vowels.
